(19) United States
(12) Patent Application Publication
(10) Pub. No.: US 2026/0079005 A1
(43) Pub. Date: Mar. 19, 2026

(54) SYSTEM AND METHOD FOR OPTICAL TETHER DEPARTURE ANGLE MEASUREMENT FROM WINCH

(71) Applicant: The United States of America, as represented by the Secretary of the Navy, Arlington, VA (US)

(72) Inventors: Kurt Arthur Talke, San Diego, CA (US); Aaron Burmeister, La Mesa, CA (US); Gregory Trail Kogut, San Diego, CA (US); Frederick Christopher Birchmore, La Mesa, CA (US)

(73) Assignee: The United States of America, as represented by the Secretary of the Navy, Arlington, VA (US)

(21) Appl. No.: 18/887,155

(22) Filed: Sep. 17, 2024

(51) Int. Cl. G01B 11/26; B64F 5/60; B64U 10/60

(52) U.S. Cl. CPC G01B 11/26; B64F 5/60; B64U 10/60

(57) ABSTRACT

The present invention involves systems and methods for tether length management between an uncrewed aerial vehicle (UAV), e.g., a drone, and a surface vehicle (SV), dynamically moving ground vehicle or an uncrewed SV (USV) base station. The tether departure angle control methodology of the present invention utilizes an optical method of measuring tether departure angle, which in combination with relative locations of the SV and UAV allows for a dynamic hanging tether management.

### CROSS-REFERENCE TO RELATED APPLICATIONS

This US patent application is related to U.S. patent application Ser. No. 16/874,026, filed May 14, 2020, titled: “TETHER MANAGEMENT SYSTEM FOR A TETHERED UAV”, now U.S. Pat. No. 11,440,680 B2, issued Sep. 13, 2022, which in turn claims benefit and priority to U.S. Provisional Patent Application No. 62/872,170, filed Jul. 9, 2019, titled: “AUTONOMOUS TETHER MANAGEMENT SYSTEM FOR A SLACK HANGING TETHER FOR A UAV”, Navy Case Number 110851, now expired. This US patent application is also related to U.S. patent application Ser. No. 18/463,137, filed Sep. 7, 2023, titled: “AUTONOMOUS TETHER MANAGEMENT SYSTEM AND METHOD FOR AN UNMANNED AERIAL AND SURFACE VEHICLE TEAM”, Navy Case Number 211589, pending, which in turn claims benefit and priority to U.S. Provisional Patent Application No. 63/505,377, filed May 31, 2023, titled: “AUTONOMOUS HANGING TETHER MANAGEMENT SYSTEM AND METHOD FOR AN UNMANNED AIR AND SURFACE VEHICLE TEAM”, now expired. The contents of all of the above-referenced patent applications are hereby incorporated by reference for all purposes.

### FEDERALLY-SPONSORED RESEARCH AND DEVELOPMENT

The United States Government has ownership rights in this invention. Licensing and technical inquiries may be directed to the Office of Research and Technical Applications, Naval Information Warfare Center Pacific, Code 72120, San Diego, CA, 92152; voice: (619) 553-5118; email: NIWC_Pacific_T2@navy.mil. Reference Navy Case Number 211787.

### BACKGROUND OF THE INVENTION

### Field of the Invention

The present invention relates generally to tethered uncrewed aerial vehicles (UAVs). More particularly, the present invention relates to an UAV tethered to a surface vehicle (SV), tether management methods and systems. Still more particularly, the present invention is directed to tether departure angle measurement using 2-dimensional (2D) light detection and ranging (LIDAR) technology. It will be understood that a SV in the context of this invention could be any kind of vehicle undergoing dynamic motion, e.g., and not by way of limitation, a manned SV, uncrewed SV (USV), a small boat on open water, or even a ground vehicle traversing a hilly road.

### Description of Related Art

Tethered multi-rotor UAVs have become widely prevalent in the surveillance, communications, and first-responder communities and readily available in recent years due to many different commercially available products. The tether, acting as a power and/or data umbilical, allows a UAV to overcome its most significant limitation: short-duration missions often limited to less than 30 minutes, see, e.g., J. Kim, B. D. Song, and J. R. Morrison, “On the scheduling of systems of UAVs and fuel service stations for long-term mission fulfillment,” Journal of Intelligent & Robotic Systems, vol. 70, pp. 347-359, April 2013. By not carrying a heavy power source, a UAV's payload capacity increases significantly and its endurance becomes essentially infinite, see, e.g., S. Y. Choi, B. H. Choi, S. Y. Jeong, B. W. Gu, S. J. Yoo, and C. T. Rim, “Tethered aerial robots using contactless power systems for extended mission time and range,” in 2014 IEEE Energy Conversion Congress and Exposition (ECCE), pp. 912-916, September 2014; C. Papachristos and A. Tzes, “The power-tethered UAV-UGV team: A collaborative strategy for navigation in partially-mapped environments,” in 22nd Mediterranean Conference on Control and Automation, pp. 1153-1158 June 2014 and L. Sandino, M. Bejar, K. Kondak, and A. Ollero, “Advances in modeling and control of tethered unmanned helicopters to enhance hovering performance,” Journal of Intelligent & Robotic Systems, vol. 73, no. 1, pp. 3-18, 2014. Unfortunately, a tether conversely limits the mobility of the UAV and introduces the challenge of tether management. Tethered flight is also accompanied by some payload limitations as it introduces additional downward forces on the UAV due to tether weight and tension. These forces must be overcome by increasing UAV thrust, thereby potentially reducing the UAV payload capacity, available power budget, and limiting flight altitude.

Conventional tethered-UAV systems typically employ a taut tether management approach to avoid tether oscillations, see, e.g., G. Schmidt and R. Swik, “Automatic hover control of an unmanned tethered rotorplatform,” Automatica, vol. 10, pp. 393-394, January 1974. Conventional tethered-UAV systems may further employ a taut tether management approach to improve flight stability, see, e.g., D. Ferreira de Castro, J. S. Santos, M. Batista, D. Antônio dos Santos, and L. C. Góes, “Modeling and control of tethered unmanned multicopters in hovering flight,” in AIAA Modeling and Simulation Technologies Conference, American Institute of Aeronautics and Astronautics, June 2015; S. Lupashin and R. D'Andrea, “Stabilization of a flying vehicle on a taut tether using inertial sensing,” in 2013 IEEE/RSJ International Conference on Intelligent Robots and Systems, pp. 2432-2438 November 2013; M. M. Nicotra, R. Naldi, and E. Garone, “Taut cable control of a tethered UAV,” IFAC Proceedings Volumes, vol. 47, no. 3, pp. 3190-95, 2014, 19th IFAC World Congress; Y. Ouchi, K. Kinoshita, K. Watanabe, and I. Nagai, “Control of position and attitude of the tethered X4-Flyer,” in 2014 IEEE/SICE International Symposium on System Integration, pp. 706-711, December 2014 and L. A. Sandino, M. Bejar, K. Kondak, and A. Ollero, “On the use of tethered configurations for augmenting hovering stability in small size autonomous helicopters,” Journal of Intelligent & Robotic Systems, vol. 70, no. 1, pp. 509-525, 2013.

Conventional tethered-UAV systems may also employ a taut tether management approach to enhance landing capability, see, e.g., B. Ahmed and H. R. Pota, “Backstepping-based landing control of a RUAV using tether incorporating flapping correction dynamics,” in 2008 American Control Conference, pp. 2728-2733 June 2008; S.-R. Oh, K. Pathak, S. K. Agrawal, H. R. Pota, and M. Garratt, “Approaches for a tether-guided landing of an autonomous helicopter,” IEEE Transactions on Robotics, vol. 22, pp. 536-544, June 2006 and L. A. Sandino, D. Santamaria, M. Bejar, A. Viguria, K. Kondak, and A. Ollero, “Tether-guided landing of unmanned helicopters without GPS sensors,” in 2014 IEEE International Conference on Robotics and Automation (ICRA), pp. 3096-3101 May 2014. Conventional tether management techniques typically rely on taut tether control to avoid tether oscillations, improve flight stability, or enhance landing capabilities. For example, conventional approaches to tethered UAV-SV systems may include the UAV maintaining tension, a tension monitoring tether management system that continuously reels in any slack, or a clutch-based tension system.

Such conventional tether systems neglect the reduced payload capacity and increased UAV thrust requirement by employing either no tether management while the UAV maintains tension with linear (see, e.g., Nicotra et al. above) and nonlinear flight controllers (see, e.g., M. M. Nicotra, R. Naldi, and E. Garone, “Nonlinear control of a tethered UAV: the taut cable case,” CoRR, 2016) or by employing a tension-monitoring winch mechanism that continuously reels in any slack tether length, see, e.g., U.S. Pat. No. 10,399,704 B2 to Briggs, I V et al.

Generally, such conventional tether systems described above only consider a stationary base station, not a base station undergoing dynamic motion. The scenario of tethered UAVs with moving platforms has been considered but under taut conditions and with no experimental validation, see, e.g., M. Tognon, S. S. Dash, and A. Franchi, “Observer-based control of position and tension for an aerial robot tethered to a moving platform,” IEEE Robotics and Automation Letters, vol. 1, pp. 732-737, July 2016.

Other conventional approaches have considered non-taut-tethered flight using a reactive tether management approach, see, e.g., L. Zikou, C. Papachristos, and A. Tzes, “The power-over-tether system for powering small UAVs: Tethering-line tension control synthesis,” in 2015 23rd Mediterranean Conference on Control and Automation (MED), pp. 681-687, June 2015. Adding a tether to a UAV provides the opportunity to measure additional variables (such as the rotational position and velocity of the reel, tether tension, and tether departure angle) which can be used to perform non-GPS-based UAV position estimation. For instance, the tether arrival angle at the UAV can be measured (see, e.g., L. A. Sandino, M. Bejar, K. Kondak, and A. Ollero, “A square-root unscented Kalman filter for attitude and relative position estimation of a tethered unmanned helicopter,” in 2015 International Conference on Unmanned Aircraft Systems (ICUAS), pp. 567-576, June 2015) and/or the tension at the UAV estimated (see, e.g., A. Al-Radaideh and L. Sun, “Self-localization of a tethered quadcopter using inertial sensors in a GPS-denied environment,” in 2017 International Conference on Unmanned Aircraft Systems (ICUAS), pp. 271-277, June 2017) and incorporated into the state estimation algorithm. Others have used a non-taut catenary cable model for position estimation of the UAV, see, e.g., B. Galea and P. G. Kry, “Tethered flight control of a small quadrotor robot for stippling,” in 2017 IEEE/RSJ International Conference on Intelligent Robots and Systems (IROS), pp. 1713-1718 September 2017; S. Kiribayashi, K. Yakushigawa, and K. Nagatani, “Position estimation of tethered micro unmanned aerial vehicle by observing the slack tether,” in 2017 IEEE International Symposium on Safety, Security and Rescue Robotics (SSRR), pp. 159-165, October 2017 and A. Borgese, D. C. Guastella, G. Sutera, and G. Muscato, “Tether-based localization for cooperative ground and aerial vehicles,” IEEE Robotics and Automation Letters, vol. 7, no. 3, pp. 8162-8169, 2022.

Hanging or slack tether management is disclosed in Talke et al., “Autonomous hanging tether management and experimentation for an unmanned air-surface vehicle team,” Journal of Field Robotics, vol. 39, no. 6, pp. 869-887, 2022, (hereinafter “Talke et al. #1”) incorporated herein by reference for all purposes. This technical paper discloses a tether management reference model, controller, and estimator to automatically reel in/out the tether to a desired heave-robustness tether length while preventing the tether from fouling with the SV. Compared to taut-tether UAV operation, the use of a hanging tether was shown to minimize the downforce that the tether applies to the UAV, ultimately decreasing power consumption by the UAV-SV team while maintaining the required margins of safety on the thrust of the UAV. The varying sag of the tether inherently compensates for the fast-acting dynamics of an ocean environment. Flying on a non-taut, or hanging tether, was shown to effectively decouple the motion of the UAV and the SV in lab-based experimentation.

Validation of the above described approach to hanging tether management control employing a reference tether length model is described in Talke et al., “Autonomous Hanging Tether Management and Experimentation for a UAV-USV Team: Sea Trials” (hereinafter “Talke et al. #2”) IEEE OCEANS 2023 Conference, June 2023, incorporated herein by reference for all purposes.

Alternatively, hanging tether management control may also be achieved by measuring the tether departure angle. The winch system disclosed in Applicant's U.S. Pat. No. 11,440,680 B2 to Talke et al., employed a passive-tether departure angle measurement approach. However, the inventors discovered that this physical method of measuring the tether departure angle from the winch inherently colored the measurement of the tether, inducing a deadband in measurement, see Talke et al. #1 (cited above). As used herein, “coloring” relates to the noise spectrum of the system. If the system is a natural process, there will be white noise (full spectrum) plus some natural frequency of the tether. Thus, “coloring” means that there is some added spectral noise, or applied motions, or added noise to the tether because it is constrained.

Zikou et al. (cited above) discloses a time-of-flight sensor-based approach to tether departure angle measurement. However, in Zikou et al., the tether is constrained, and the range finder is limited to 1 dimension, i.e., straight up in the z-direction (vertical) in order to apply measurement from a distance sensor. As the inventors discovered, constraining the tether affects the dynamics of the tether and “colors” the measurement process.

Friesen et al., “A Tensegrity-Inspired Compliant 3-DOF Compliant Joint”, 2018 IEEE International Conference on Robotics and Automation (ICRA), May 21-25, 2018, Brisbane, Australia, pp. 3301-3306, discloses another approach to departure angle measurement, wherein the tether exits a guideway around a small pulley wheel operating as a mechanical follower that can be measured using an encoder. However, the Friesen et al. method is designed for taut systems and would again “color” the tether measurement in hanging, or slack tether systems such as the present invention.

In view of the foregoing and for other reasons that will become evident, there exists a need in the art for improved tether departure angle measurement methods and systems for use in autonomous hanging tether management for UAV-SV teams.

### SUMMARY OF THE INVENTION

An embodiment of a system for measuring tether departure angle, a, from a winch mounted to a surface vehicle (SV) used to reel and payout an umbilical tether attached to an uncrewed aerial vehicle (UAV) is disclosed. The embodiment of the system may include a support structure connected to the winch. The embodiment of the system may further include an optical measurement device attached to the support structure and configured for optically measuring a dynamic distance, a, along an optical path from the optical measurement device to the tether extending from a tether guide departure point on the winch during operation of the tethered UAV. The embodiment of the system may further include a processor in communication with the optical measurement device for calculating the tether departure angle, a, using: (1) the dynamic distance, a, output from the optical measurement device and forming side a of a triangle, (2) a predetermined distance, c, measured from the optical measurement device to a tether guide departure point on the winch forming side c of the triangle, (3) a predetermined angle, B, measured between the sides a and c of the triangle and (4) a predetermined angle, θ, measured between a vertical line and the side c of the triangle.

An embodiment of a method for measuring tether departure angle, a, from a winch mounted to a surface vehicle (SV) used to reel and payout an umbilical tether attached to an uncrewed aerial vehicle (UAV) under slack tether control is disclosed. The embodiment of the method may include providing a support structure connected to the winch. The embodiment of the method may further include providing an optical measurement device attached to the support structure and configured for generating a series of returns from within an area slice within a field-of-view (FoV) including the tether, each return provided in polar coordinates including a range from the optical measurement device to the tether and an angle relative to an origin angle. The embodiment of the method may further include converting each return to Cartesian coordinates. The embodiment of the method may further include box filtering each of the Cartesian returns to eliminate Cartesian returns outside of minimum and maximum x and y positions of the tether within the FoV to obtain box filtered returns. The embodiment of the method may further include morphologically filtering each of the box filtered returns by grouping adjacent box filtered returns into groupings, each grouping having a size based on total number of adjacent returns to obtain sized groupings. The embodiment of the method may further include selecting a largest of the sized groupings as most likely to represent the tether. The embodiment of the method may further include determining a centroid position within the largest grouping and a distance, a, from the optical measurement device to the centroid position. The embodiment of the method may further include determining the tether departure angle, a. Determining the tether departure angle, a, according to this embodiment of the method may include using the distance, a, representing side a of a triangle; a predetermined distance, c, measured from the optical measurement device to a tether guide departure point on the winch, the distance, c, representing side c of the triangle; a predetermined angle, B, measured between the sides a and c of the triangle; and a predetermined angle, θ, measured between a vertical line and the side c of the triangle.

An embodiment of a kit for upgrading a winch to optically measure a tether departure angle, the winch including a base frame configured for mounting to a surface vehicle (SV), a passive tether guide mounted to the base frame from which the tether departure angle is measured relative to horizontal, the winch further including a reel supported between two base frame support arms of the base frame, the reel configured to reel and payout an umbilical tether in coordination with the passive tether guide and rotationally driven by a motor, the tether connected at one end to the winch mounted to the SV, the tether passing through the passive tether guide, and the tether connected at an opposite end to an uncrewed aerial vehicle (UAV) is disclosed. The embodiment of the kit may include a support structure including two angled support brackets, each angled support bracket having a proximal end and a distal end, each of the proximal ends configured for mounting to a respective one of the two base frame support arms, and a bridge configured to connect between the distal ends of the two angled support brackets. The embodiment of the kit may further include an optical measurement device configured for mounting to the bridge and aimed toward the tether during operation of the winch and configured to output dynamic distance measurements from the optical measurement device to the tether during operation of the winch, the dynamic distance measurements used to calculate the tether departure angle.

### BRIEF DESCRIPTION OF THE DRAWINGS

The following drawings illustrate exemplary embodiments for carrying out the invention. Like reference numerals refer to like parts in different views or embodiments of the present invention in the drawings.

FIG. 1 is a schematic diagram of a tethered SV-UAV team in an ocean environment with waves, according to the present invention.

FIG. 2 is a free body diagram of a catenary curve through specific endpoints, A, B, and C.

FIG. 3A is a graph of tether departure angle, a, empirical results as a function of offset, according to the present invention.

FIG. 3B is a graph of tether departure angle, a, empirical results as a function of relative position, Δx/Δy, according to the present invention.

FIG. 4A is a graph comparing tether departure angle as a function of time based on theory and measurement in contrast to the geometric angle between a SV and a UAV for a typical experiment, without the present invention.

FIG. 4B is a graph of normalized cross-correlation versus Tau measured in seconds between the measured and theoretical tether departure angles, without the present invention.

FIGS. 5A and 5B are front-right and left-rear perspective view exploded diagrams, respectively, of an exemplary winch system, according to the present invention.

FIG. 6 is a side view of an exemplary winch system illustrating the geometry used to calculate tether departure angle, a, according to the present invention.

FIG. 7 is a diagram illustrating the Cartesian box bound approach to eliminate non-tether returns from a 2D LIDAR, according to the present invention.

FIG. 8 is a conceptual image of LIDAR returns in Cartesian space, according to the present invention.

FIGS. 9A and 9B are left-front perspective and right-rear perspective views, respectively, of exemplary winch systems, according to the present invention.

FIG. 10 is a block diagram of an exemplary system for optical tether departure angle measurement from a winch, according to the present invention.

FIG. 11 is a flowchart of an exemplary method for measuring tether departure angle, a, from a winch mounted to a surface vehicle (SV) used to reel and payout an umbilical tether attached to an uncrewed aerial vehicle (UAV) under slack tether control, according to the present invention.

### DETAILED DESCRIPTION

The disclosed methods and systems below may be described generally, as well as in terms of specific examples and/or specific embodiments. For instances where references are made to detailed examples and/or embodiments, it should be appreciated that any of the underlying principles described are not to be limited to a single embodiment but may be expanded for use with any of the other methods and systems described herein as will be understood by one of ordinary skill in the art unless specifically otherwise stated.

The invention disclosed herein is useful for the autonomous tether management of a tethered, uncrewed aerial vehicle (UAV). A tethered UAV system allows for potentially unlimited flight times. Power to operate the UAV may be supplied up through the tether and data from the UAV may be downloaded through the tether. It will be understood that other embodiments of the invention may employ a “power only” or a “data only” tether. Management of the tether is the heart of this invention.

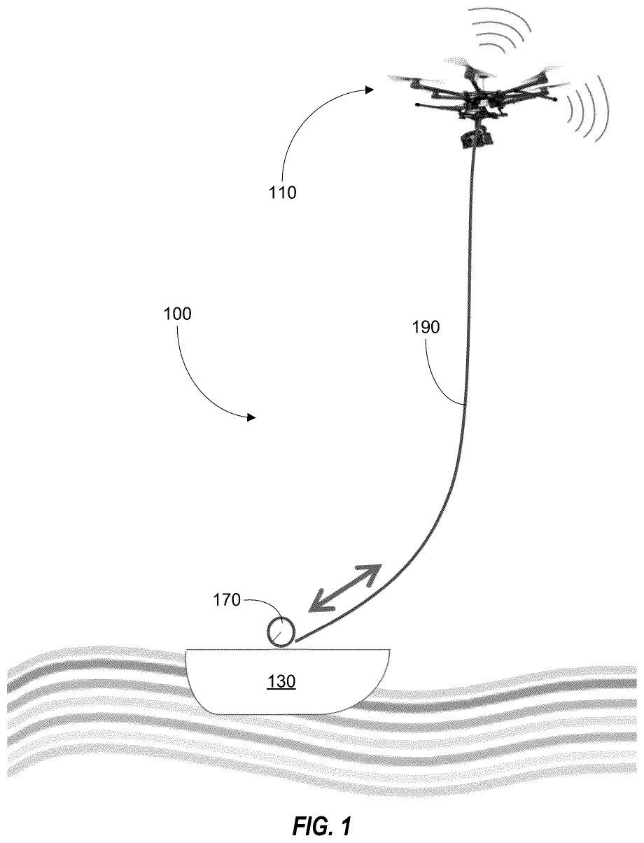

FIG. 1 is a schematic diagram of a tethered UAV-SV team 100 in an ocean environment with waves, according to the present invention. As shown in FIG. 1, the UAV 110 is tethered via umbilical tether 190 to a SV 130 with its associated winch 170 (also referred to herein as a “winch system”, or “reel”, or “spool”, or “drum”) configured for adjusting length of the tether 190, indicated by the double-headed arrow. According to a particular embodiment, the umbilical tether 190 may provide power from the SV 130 up to the UAV 110 and may also act as a wired radio (data) link down to the SV 130. According to other embodiments, umbilical tether 190 may provide communications only. Current embodiments of the system allow the UAV 110 to fly up to 200+ m altitude while maintaining position, orientation, and altitude for communication during intelligence, surveillance, and reconnaissance (ISR) missions as shown in FIG. 1.

According to particular embodiments, the UAV 110 may be tethered 190 to a small (e.g., length of 3 to 7 meters) SV 130. It will be understood that length, size or type (crewed/uncrewed, ground- or water-based) of the SV 130 is not a limiting factor of the present invention, only that it may undergo dynamic motion. The exemplary water-based SV 130 may be subject to a dynamic ocean environment denoted as non-linear parallel lines in FIG. 1. The system and method used to control the winch 190 and thereby the tether length is the subject of the present invention. Again, it will be understood that the inventive systems and methods disclosed herein are not limited to a SV 130 being a small boat on water as depicted in FIG. 1. Rather, SV 130 may also be a water-based USV, a ground vehicle, e.g., a truck traversing a road or hill, or any other suitable ground-traversing vehicle that may have associated dynamic motion at the winch platform.

### Tether Departure Angle Theory

Talke et al., “Catenary Tether Shape Analysis for a UAV—USV Team”, 2018 IEEE/RSJ International Conference on Intelligent Robots and Systems (IROS), Madrid, Spain, Oct. 1-5, 2018, (hereinafter referred to as “Talke et al. #3”), provides a comprehensive analysis of catenary tether shape with various models for using relative positions of the USV to the UAV as a feedback mechanism to manage hanging tether length. The contents of Talke et al. #3 are hereby incorporated by reference for all purposes as if fully set forth herein. Inter alia, Talke et al. #3 describes a catenary model including tether departure angle as a physical reference for a control system. In order to introduce the control model based on tether departure angle, it is useful provide a catenary curve diagram.

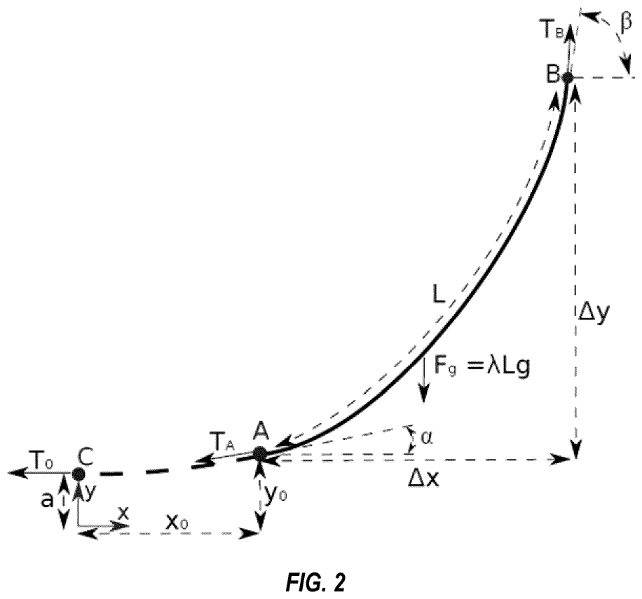

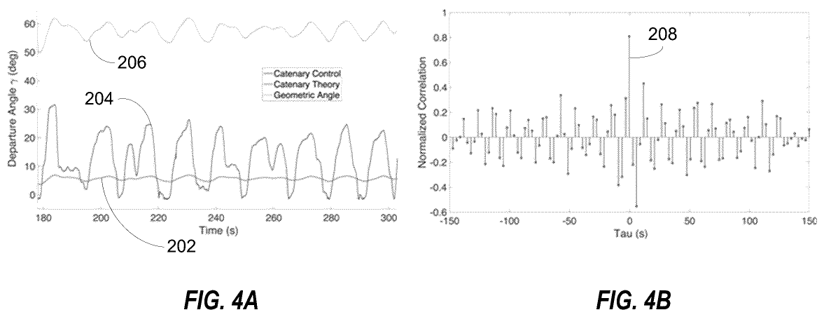

FIG. 2 is a free body diagram of a catenary curve through specific endpoints, A, B, and C. The weight of the tether, F_{g}, with length L, is offset by the tension at the endpoints, T₀ or T_{A}, and T_{B}. Δx and Δy correspond to the relative position, and drive the solution of catenary parameter, a. Point C, the vertex, is used for the determination of the resulting differential equation. x₀ and y₀ represent a shift in the coordinate system once the catenary parameter, a, has been determined. The departure angle at the winch is labeled, α. Given suitable empirical measurements of tether angle vs. relative position, Δx/Δy, the departure angle, α, may be calculated. However, as noted above, measuring the tether departure angle by physical contact from the winch inherently colors the measurement of the tether departure angle, inducing a deadband in measurement. This technical problem with physical tether departure angle measurement is further explained with reference to FIGS. 4A and 4B, below.

FIG. 4A is a graph comparing tether departure angle, α, as a function of time based on theory 202 and measurement 204 in contrast to the geometric angle 206 relative to horizontal between a SV-UAV team for a typical experiment, in the absence of the present invention. More particularly, FIG. 4A illustrates theoretical tether departure angle 202 based on the measured tether length and relative position, see relatively smooth red line labeled “Catenary Theory” in the legend, and ranging between 0° and 10°. FIG. 4A further illustrates the measured tether departure angle 204 during Catenary Control, see jagged blue line labeled “Catenary Control” in the legend, and ranging from about −3° to about 32°. Departure angle measurement 204 under catenary control in this instance employs a physical means, namely an encoder on a guide arm of the winch. Finally, FIG. 4A illustrates the geometric angle 206 between SV and UAV, which is based solely on relative positions of a SV and an UAV, see yellow line 206 ranging from about 50° to about 62°.

As can be seen in FIG. 4A, the catenary control 204 curve has an approximately 20° dead-band gap in measurement capability as seen by the periodic and generally vertical lines during direction changes. This error in measurement occurs when the tether reel switches between reeling in and paying out, and the tether contact point on the follower switches from one side to the other, thus causing a “stretching out” of the departure angle measurement 204. FIG. 4B is a graph of normalized cross-correlation versus Tau measured in seconds between the measured and theoretical tether departure angles. As shown in FIG. 4B, the deadband error can also be inferred from the correlation spike 208 at Tau 0. Note that FIGS. 4A and 4B are reproduced from FIGS. 12(a) and 12(b) of Talke et al. #1 (cited above).

The present invention is directed to optical systems and methods for performing tether departure angle measurement that alleviate the problems associated with prior art systems and methods of physically measuring the departure angle. The solution to this technical problem improves the performance of slack tether management systems used in SV-UAV teams that employ tether departure angle measurement as a feedback mechanism for tether control.

To solve this technical problem, the inventors have employed an optical method of measuring the distance from a fixed angle relative to vertical from a location above the winch system to the tether and then calculating the tether departure angle. More particularly, the inventors employ 2D LIDAR distance measuring technology with novel filtering and signal processing to accurately measure the dynamic distance to the tether in real-time. Prior to describing the optical setup and calculations necessary to determine the tether departure angle, an overview of an exemplary winch system with its various components according to the present invention, follows.

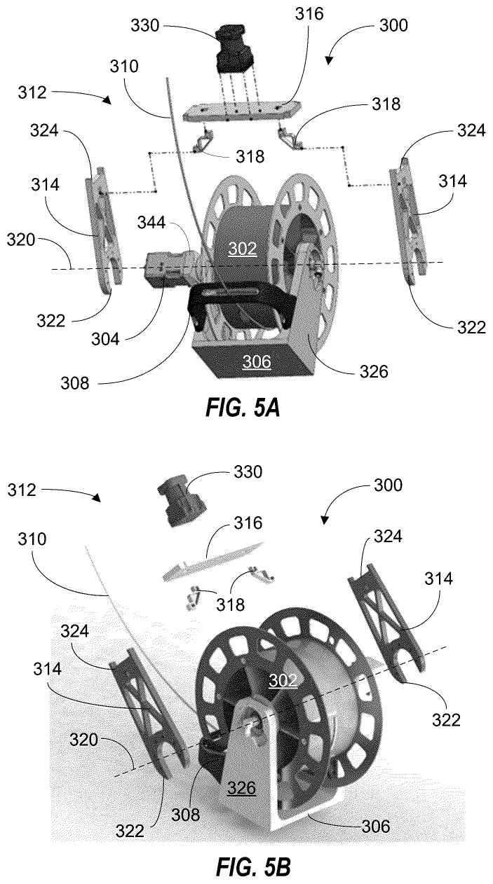

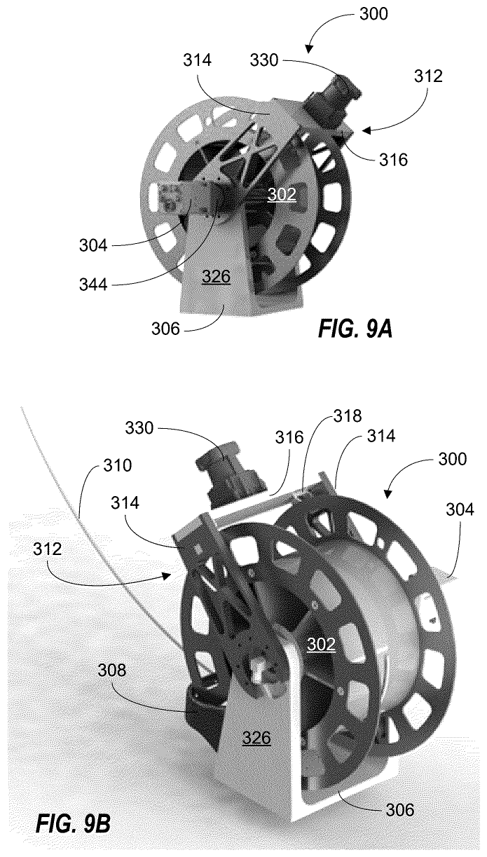

FIGS. 5A and 5B are front-right and left-rear perspective view exploded diagrams, respectively, of an exemplary winch system 300, according to the present invention. FIGS. 9A and 9B are left-front perspective and right-rear perspective views, respectively, of exemplary winch systems 300, according to the present invention. The exemplary winch system 300 may include a reel 302 driven by a motor 304, mounted to a base frame 306 including a passive tether guide 308 with tether 310 passing through. According to one embodiment, motor 304 may be an encoder-geared direct current (DC) brushless motor. According to a particular embodiment of winch system 300, the motor 304 may be mated to a gearbox 344 (best illustrated in FIG. 5A and partially in FIG. 9A) used to adjust the rotational speed of the motor 304. The base frame 306 with its opposed support arms 326 supports the reel 302 and the motor 304 along the axis of rotation, see dashed lines 320 in FIGS. 5A and 5B. The exemplary winch system 300 may further include a support structure, shown generally at arrow 312. The support structure 312 (collectively including 314, 316 and 318) may include two angled support brackets 314 configured to attach to bridge 316 in cooperation with two step-like brackets 318. Each angled support bracket 314 includes a proximal end 322 configured to attach to a respective support arm 326 and a distal end 324 configured to attached opposite ends of the bridge 316. The embodiment of system 300 shown in FIG. 9A does not include the passive tether guide 308 or tether 310 for simplicity of illustration.

It will be understood that any suitable motor 304 may be employed for use in driving the winch 300, according to the present invention. One exemplary motor 304 suitable for use in the present invention is the Moog Animatics, SM23165MT Class 5 M-Style SmartMotor™, available from Moog Animatics, 1995 N C Hwy 141, Murphy, North Carolina 28906. It will be further understood that any suitable gearbox 344 (FIGS. 5A and 9A) may be mated to motor 304 to step-up or reduce rotational speed provided by the motor 304. One exemplary gearbox 344 suitable for use in the present invention is the SureGear® PGCN23-0525 planetary gearbox with a 5:1 ratio inline, for reducing rotational speed of the motor 304, available from a variety of vendors including Automation Direct, 3505 Hutchinson Rd, Cumming, GA 30040.

The bridge 316 may be configured to support an optical measurement device 330 aimed at the tether 310. According to a presently preferred embodiment, the optical measurement device 330 may be a 2D LIDAR 330. However, it will be understood that any suitable optical measurement device 330 capable of touch free measurement of the dynamic distance from the optical measurement device 330 to the tether 310 may be used consistent with the teachings of the present invention. One particular LIDAR suitable for use as the optical measurement device 330 of the present invention is the Hokuyo® UTM-30LX-EW Scanning Rangefinder, available from Hokuyo Automatic USA Corporation, 2019 Van Buren Ave, Suite A, Indian Trail, NC 28079.

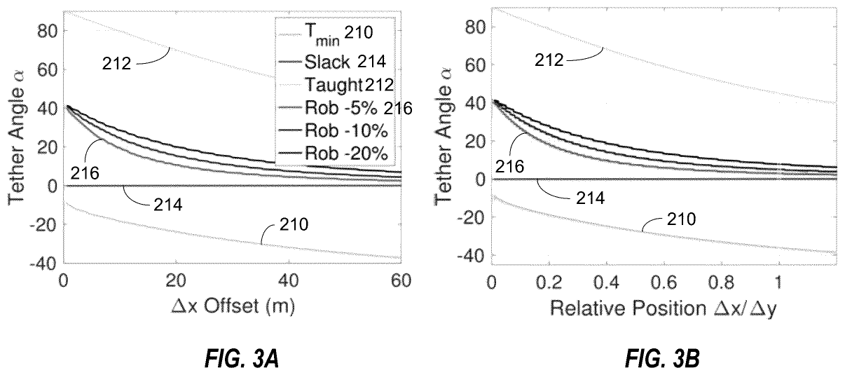

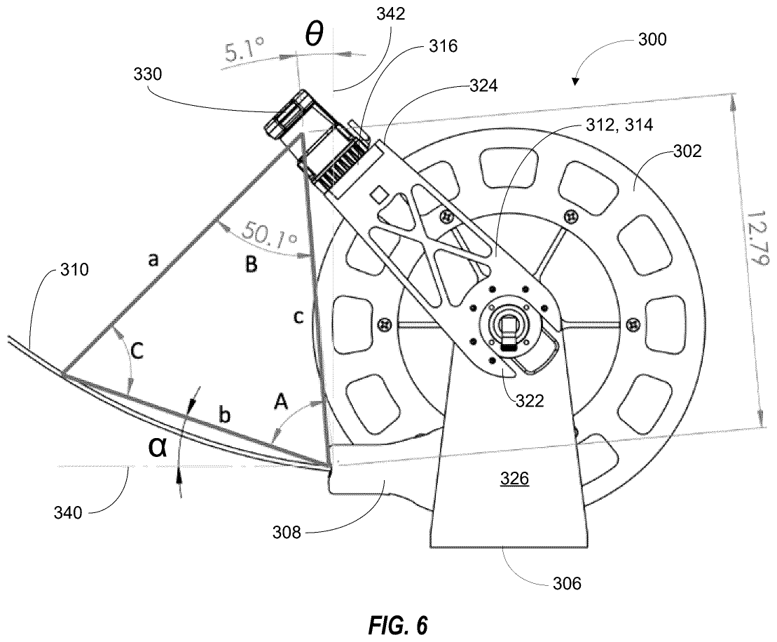

The geometric configuration used to calculate the tether departure angle using the optical measurement device 330 is explained in greater detail with reference to FIG. 6. FIG. 6 is a side view of an exemplary winch system 300 illustrating the geometry used to calculate tether departure angle, α, according to the present invention. More particularly, the exemplary winch system 300 may include a reel 302 driven by a motor 304 (not shown in FIG. 3 because hidden from view), mounted to a base frame 306 including a passive tether guide 308 with tether 310 passing through. The exemplary winch system 300 may further include a base frame 306 with opposed support arms 326 (one visible) supporting the reel 302 and motor 304 (not shown). The opposed support arms 326 (one visible) provide lateral support for the bridge 316 including two angled support brackets 314 (one visible) according to the illustrated embodiment of support structure 312.

FIG. 6 further illustrates a triangle with sides, a, b, and c, and internal angles A, B, and C. Side a represents the distance from the center of the optical measurement device 330 to an intersection of the tether 310 along the optical measurement path. Side b represents the distance from the intersection of the tether 310 along the optical measurement path and the tether exit from the passive tether guide 308. Side c represents the distance from the tether exit from the passive tether guide 308 to the center of the optical measurement device 330. Angle A is measured between sides b and c. Angle B is measured between sides a and c. Angle C is measured between sides a and b. As shown in FIG. 6, the tether departure angle, α, is measured between horizontal line 340 and side b. A tether guide departure point is defined at the intersection of sides b and c.

The fixed dimensions of an exemplary winch system 300 design provide some known quantities, namely side, c=12.79″, and angle, B=50.13°. The optical measurement device 330 provides a dynamic measurement of the distance, a, to the tether 310, side, a, of the triangle. In view of FIG. 6 and basic trigonometry, solving for the tether departure angle, α, may be assisted by application of the Law of Sines (Eq. 1), and the Law of Cosines, which can be solved for b as shown in (Eq. 2).

$$\frac{a}{sin ( A )} = \frac{b}{sin ( B )} = \frac{c}{sin ( C )} \qquad ( Eq . 1 )$$

$$b = \sqrt{{a}^{2} + {c}^{2} - 2 ac cos ( B )} \qquad ( Eq . 2 )$$

Using Eq. 2, we know a, c, and B, so we can solve for side, b, the distance from the tether exit to the intersection point of the optical measurement device 330 scan point and the tether 310. Knowing a, b, and B, we can use the first two terms of Eq. 1 to solve for angle, A, as shown in Eq. 3, below.

$$A = arcsin ( \frac{a sin ( B )}{b} ) \qquad ( Eq . 3 )$$

A small angle, θ=5.13°, is also known from the winch fixed design geometry. Small angle θ is measured between a vertical line 342 and line, c. Finally, the tether departure angle, α, is then 90° minus angle, A, minus the small angle, θ=5.13°, as shown in Eq. 4, below.

$$α = 90 ° - A - 5.13 ° \qquad ( Eq . 4 )$$

It will be understood that the known dimensions and angles with respect to the triangle illustrated in FIG. 6 and used to calculate tether departure angle, α, are for the specific embodiment described herein. One of ordinary skill in the art will appreciate that by changing the particular setup of the optical measurement device 330 relative to the tether 310, the knowns and unknowns used to calculate tether departure angle, α, will vary accordingly, but may still be ascertained by the teachings of the present invention. All such variations are considered to be within the scope of the present invention.

### Reference Tether Departure Angle Model

The development of a reference tether departure angle model suitable for use in hanging tether control of a SV-UAV team is detailed in Talke et al. #1 (cited above). One particular observation noted in Talke et al. #1 is that a minimum tether tension length exists that operating a SV-UAV team at that minimum tether tension length minimizes the UAV thrust and power consumption. Additionally, Talke et al. #3 presents a relative flying position considering robustness to vertical motion of the SV. Talke et al. #1 further describes a model for a large range of flying positions while maximizing heave robustness with reduced overall power consumption. The dynamic disturbance effects on a UAV can be minimized by operating at a tether length, L_{rob}, best suited to handle heave, i.e., the vertical displacement of the SV. The heave robustness tether length allows for equal vertical displacement of the SV to specified limits (upward and downward heave) while the tether length remains unchanged. In the upward heave case, the vertical displacement limit of the SV is chosen to be the slack tether condition, were tether departure angle, α=0 to avoid fouling of the tether. In the downward heave scenario, the vertical displacement limit is chosen to be a percentage increase in tension from the slack length tension, as further discussed in Talke et al. #3. The relevant description of that reference tether departure angle model is repeated herein for completeness.

FIG. 3A is a graph of tether departure angle, α, empirical results as a function of offset, Δy=55m, according to the present invention. FIG. 3B is a graph of tether departure angle, α, empirical results as a function of relative position, Δx/Δy, according to the present invention. The minimum tether departure angle 210 (Tₘᵢₙ, shown in green), is negative, representing the tether dipping down into the water and a high risk of fouling with the SV. The heave robustness angles are shown within the operating region between the taut length 212 and slack length 214 tether departure angles, α.

For a horizontal offset less than 50% of the flying height, the heave robustness length angles vary between 40 and 10 degrees and track the minimum tension angle 210. Thereafter, they are bounded by the slack length angle 214. The nondimensional data (as described in Talke et al. #3) may be modeled as a polynomial used to solve for the tether departure angle, α, shown in Eq. 5, below.

$$α = {c}_{1} + {c}_{2} \frac{Δ x}{Δ y} + {{c}_{3} ( \frac{Δ x}{Δ y} )}^{2} + {{c}_{4} ( \frac{Δ x}{Δ y} )}^{3} + {{c}_{5} ( \frac{Δ x}{Δ y} )}^{4} \qquad ( Eq . 5 )$$

with curve fit coefficients, c₁, c₂, c₃, c₄, and c₅, shown in Table I, below. In order to keep the R² confidence value near 1, a 4th order and only a 2nd order fit were needed for the 5% heave robustness and taut angles, respectively. These polyfit coefficients are independent of linear density of the tether.

TABLE I
Nondimensional tether departure angle polyfit coefficients

| α | c₁ | c₂ | c₃ | c₄ | c₅ | R² |
|---|---|---|---|---|---|---|
| αₘᵢₙ | −10.0482 | −49.6974 | 36.8857 | −13.2127 | — | .99 |
| αₜₐᵤₜ | 90.3299 | −62.0733 | 16.7069 | — | — | 1 |
| α_{rob-5%} | 40.3217 | −162.7497 | 309.9161 | −280.6729 | 95.8555 | .99 |
| α_{rob-10%} | 40.5363 | −105.5804 | 116.5771 | −46.5409 | — | .99 |
| α_{rob-20%} | 41.6537 | −84.6802 | 79.7592 | −28.9605 | — | .99 |

Given the empirical tether departure angle, α, vs. relative position Δx/Δy, results shown in FIG. 3B for the α_{rob-5%} line 216, and a measured departure angle, α, using the present invention, one of ordinary skill in the art could tune a controller that reels the tether 310 in/out depending on the error between the measured departure angle, α, and modeled tether departure angle, α_{rob-5%}, calculated from Eq. 5, above. Accordingly, the system and method of the present invention could be employed to control a winch operating in slack tether control based on tether departure angle, α, measurement, independently, or in conjunction with, the approach of slack control via tether length measurement disclosed in U.S. patent application Ser. No. 18/463,137.

### Optical Setup of the LIDAR

An important feature of the invention involves the proper setup of the LIDAR 330 to measure the dynamic distance, a, from the center of LIDAR 330 to the optical path intersection with tether 310. The range and horizontal field-of-view of a 2D scanning LIDAR 330 can greatly exceed the maximum bounding area the tether 310 can physically occupy. This can result in LIDAR returns off the ground, sea surface, or objects in the surrounding environment. In addition, sometimes extraneous objects may enter the volume the tether 310 moves inside. And lastly, the LIDAR 330 measurements are subject to multiple forms of measurement noise that may result in false positive returns within the tether movement volume. To account for these three forms of non-tether returns, software signal processing techniques can be used.

### Cartesian Box Bounds

One approach to eliminating non-tether returns involves Cartesian box bounds. A raw LIDAR 310 return is given in polar coordinates, i.e., a range from the sensor and the angle of the rotating sensor element relative to an origin angle. These raw returns can then be converted to Cartesian coordinates.

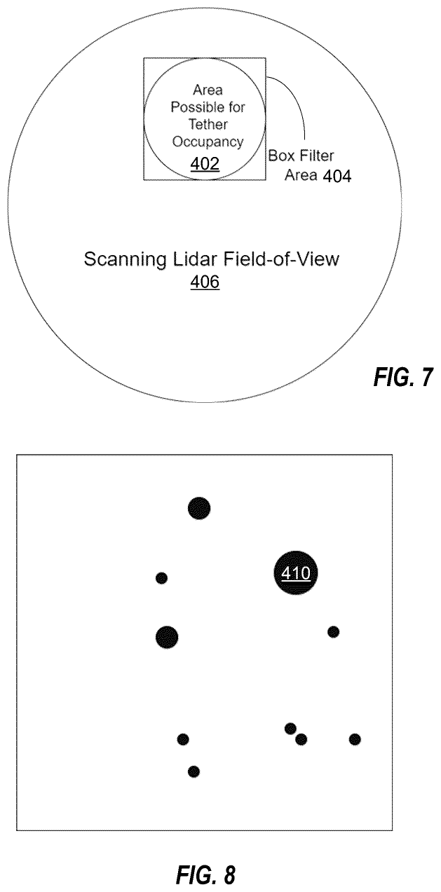

FIG. 7 is a diagram illustrating the Cartesian box bounds approach to eliminate non-tether returns from a 2D LIDAR, according to the present invention. The known maximum bounding area of the tether 402 can be described by a Cartesian box, i.e. the box filter area 404 shown in FIG. 7. The Cartesian box bounds are the minimum and maximum x and y positions of the tether 310 within the area “slice” measured by the LIDAR 330. It will be understood that 2D coordinates can be sufficient given 2D scanning LIDAR 330 is effectively a 2D planar sensor.

Given the maximum bounding area, a bounding filter can remove all LIDAR 330 returns that fall outside the Cartesian box 404, leaving only LIDAR 310 returns that could conceivably be LIDAR 330 returns from the tether 310 itself. This process accounts for both LIDAR 330 range and LIDAR 330 horizontal field-of-view (FoV). As can be appreciated from the graphical representation shown in FIG. 7, the tether 310 can only occupy and move within a small fraction of the scanning LIDAR 330 FoV. It will be understood that the bounding filter may be implemented in hardware or software or both. One of ordinary skill in the art will be familiar with bounding filters and thus the details of implementing same will not be further detailed herein.

### Morphological Filtering

After the Cartesian box filter, only returns that could possibly be returns from the tether 310 remain. However, noise and false positive returns are still possible. Most noise and false positive returns take the form of “speckle”-type noise, or randomly distributed individual returns. By comparison, true positive returns will tend to be a larger number of returns bundled together in close proximity. Morphological filtering combines individual returns into connected components or returns that are adjacent to other returns. A bundling, or collection, or blob of connected returns is referred to herein as a “grouping.”

FIG. 8 is a conceptual image of LIDAR 330 returns in Cartesian space, according to the present invention. Each black circle is a “grouping” comprised of multiple laser returns. The largest grouping, e.g. grouping 410, is likely to represent the tether 310 and not extraneous objects like water droplets, dust, or sensor noise. Each grouping has an associated size, defined as the number of individual returns that comprise the grouping. For each scanning step, the output of the morphological filtering step is a list of groupings with associated sizes.

### Final Sorting and Centroid Calculation

Given the list of groupings with associated sizes from the output of the morphological filtering step, a final sorting step may be used to select the largest grouping 410 as the grouping most likely to represent the set of true positive returns from the tether 310. The centroid position within the largest grouping 410 is then calculated as an estimate of the true location of the center of the tether 310 along with its associated distance, a.

### System Integration

The integration of the optical setup and mathematics used to perform the calculations described herein may be implemented using a Docker® Container Image and the Robot Operating System (ROS®). However, the computational overhead may overload a single board computer implementation. A more computationally efficient embodiment of the present invention may implement the LIDAR driver coding along with the masking/filtering computations in C++. It will be understood that one of ordinary skill in the art will have sufficient knowledge to implement the inventive concepts in any suitable combination of hardware, software or both. Accordingly, detailed description of such hardware/software implementations will not be further elaborated herein.

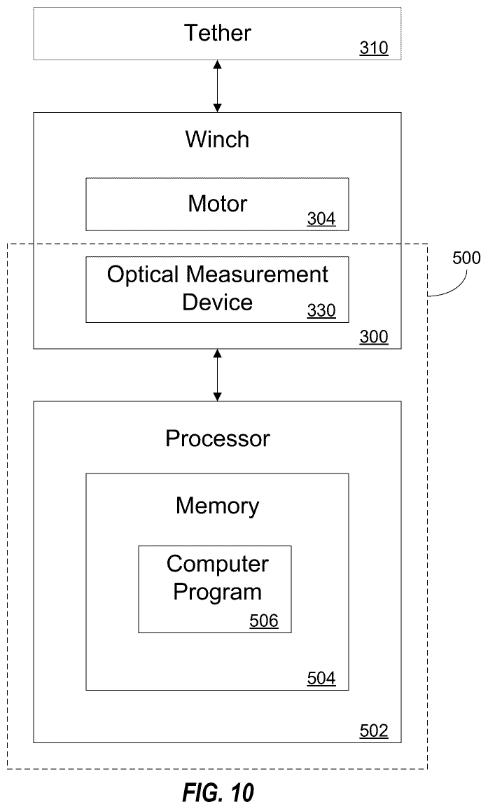

FIG. 10 is a block diagram of an exemplary system 500 (dashed box) for optical tether departure angle measurement from a winch 300, according to the present invention. As shown in FIG. 10 a winch 300 controls the tether 310 via a motor 304 driving the reel 302 (not shown) upon which the tether 310 is wound. The embodiment of winch 300 may further includes an optical measurement device 330 used to measure a distance, a, to the tether 310 during operation. The embodiment of system 500 may further include a processor 502 having a memory 504 for storing data and also for storing one or more executable computer programs 506. The one or more executable computer programs 506 may be used to calculate the tether departure angle, α, based on the distance, a, and other known dimensions of the optical setup as described herein. The processor 502 may be configured to receive output from the optical measurement device 330 and perform the calculations necessary to determine the tether departure angle, α, which in turn may be used by a separate controller (not shown), or for use by the processor 502 for controlling the winch 300 and its attached tether 310 via motor 304. It will be understood that the one or more computer programs 506 stored in memory 504 may be configured to executed steps of an exemplary method 600 for determining the tether departure angle, α, as disclosed herein. It will also be understood that processor 502 may be a controller integrating various inputs from various sensors located on a UAV or SV including inertial measurement units, differential global positioning systems, and wired radio systems transmitting data through the umbilical tether 310, see, e.g., U.S. patent application Ser. No. 18/463,137, FIG. 15 and related discussion therein. An exemplary controller for implementing processor 502 of system 500 is the BeagleBone® Blue, Part No. BBONE-BLUE, available from a number of vendors including Newark, 300 S Riverside Plaza, Suite 2200, Chicago, IL 60606. However, it will be understood that any suitable processor 502 or controller (not shown) may be used consistent with the teachings of the present invention.

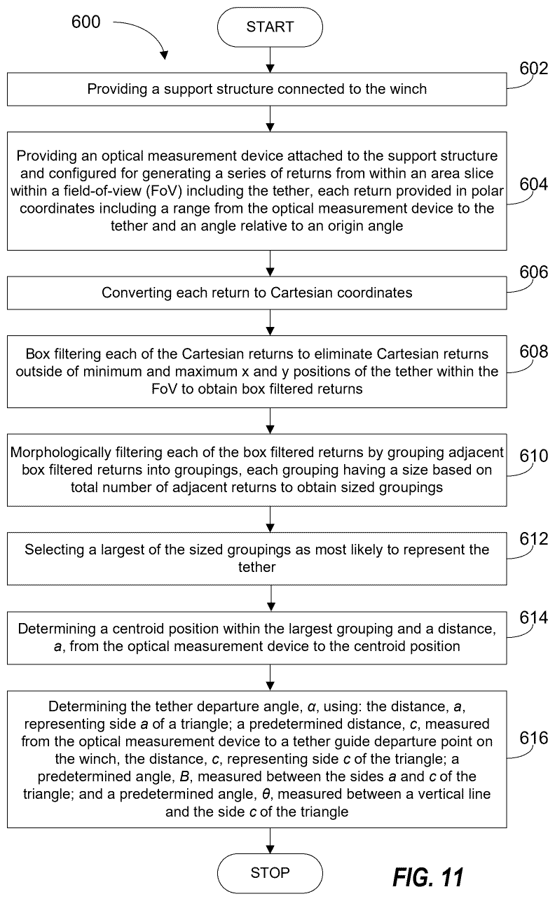

FIG. 11 is a flowchart of an exemplary method 600 for measuring tether departure angle, α, from a winch mounted to a SV used to reel and payout an umbilical tether attached to an UAV under slack tether control, according to the present invention. The exemplary method 600 may include providing 602 a support structure connected to the winch. According to a particular embodiment, the provided 602 support structure may be support structure 312 including angled support brackets 314 and bridge 316 and step-like brackets 318 as disclosed herein.

The exemplary method 600 may further include providing 604 an optical measurement device attached to the support structure and configured for generating a series of returns from within an area slice within a FoV including the tether, each return provided in polar coordinates including a range from the optical measurement device to the tether and an angle relative to an origin angle. According to particular embodiments of method 600, the optical measurement device may be optical measurement device 330, or a LIDAR 406 as disclosed herein.

The exemplary method 600 may further include converting 606 each return from polar coordinates to Cartesian coordinates to obtain Cartesian returns. The exemplary method 600 may further include box filtering 608 each of the Cartesian returns to eliminate Cartesian returns outside of minimum and maximum x and y positions of the tether within the FoV to obtain box filtered returns. The exemplary method 600 may further include morphologically filtering 610 each of the box filtered returns by grouping adjacent box filtered returns into groupings, each grouping having a size based on total number of adjacent returns to obtain sized groupings.

The exemplary method 600 may further include selecting 612 a largest of the sized groupings as most likely to represent the tether. The exemplary method 600 may further include determining 614 a centroid position within the largest grouping and a distance, a, from the optical measurement device to the centroid position.

The exemplary method 600 may further include determining 616 the tether departure angle, α. The departure angle, α, may be determined using: (1) the distance, a, representing side a of a triangle, (2) a predetermined distance, c, measured from the optical measurement device to a tether guide departure point on the winch, the distance, c, representing side c of the triangle, (3) a predetermined angle, B, measured between the sides a and c of the triangle, and (4) a predetermined angle, θ, measured between a vertical line and the side c of the triangle. A particular step of determining 616 departure angle, α, may be as disclosed herein and with reference to the triangle shown in FIG. 6.

According to another embodiment of method 600, the triangle may further include a side b of the triangle extending from the tether guide departure point to an intersection of the side a at the tether, an angle A measured between the sides band c, an angle C measured between the sides a and b, and the tether departure angle, α, is measured between the side b and a horizontal line. According to yet another embodiment of method 600, the departure angle, α, may be calculated according to Eq. 6, below:

$$α = 90 ° - arcsin ( \frac{a sin ( B )}{\sqrt{{a}^{2} + {c}^{2} - 2 ac cos ( B )}} ) - θ \qquad Eq . 6$$

It will be understood that Eq. 6 is derived from substituting Eq. 3 into Eq. 4.

According to still another embodiment of method 600, the optical measurement device may be a 2D LIDAR. According to a particular embodiment of method 600, the 2D LIDAR may be a Hokuyo® UTM-30LX-EW.

In view of the particular system and method embodiments described herein with reference to the drawings, more general embodiments of systems and kits for optically measuring tether departure angle, α, according to the present invention are disclosed, below.

An embodiment of a system for measuring tether departure angle, α, from a winch mounted to a SV used to reel and payout an umbilical tether attached to an UAV is disclosed. The system embodiment may include a support structure connected to the winch. The system embodiment may further include an optical measurement device attached to the support structure and configured for optically measuring a dynamic distance, a, along an optical path from the optical measurement device to the tether extending from a tether guide departure point on the winch during operation of the tethered UAV. The system embodiment may further include a processor in communication with the optical measurement device for calculating the tether departure angle, α, using: (1) the dynamic distance, a, output from the optical measurement device and forming side a of a triangle, (2) a predetermined distance, c, measured from the optical measurement device to a tether guide departure point on the winch forming side c of the triangle, (3) a predetermined angle, B, measured between the sides a and c of the triangle and (4) a predetermined angle, θ, measured between a vertical line and the side c of the triangle. A particular embodiment of this system and its optical setup including the referenced triangle is illustrated in FIG. 6 and described herein. According to a particular embodiment of a system for measuring tether departure angle, α, the optical measurement device may be 2D LIDAR.

According to another embodiment of a system for measuring tether departure angle, α, the support structure may further include two angled support brackets, each of the angled support brackets may be configured with a proximal end for mounting to respective base frame support arms and a bridge plate having opposed ends, each opposed end configured for attachment to respective distal ends of the angled support brackets. Particular embodiments of a support structure 312, angled support brackets 314 and bridge plate 316 according to this system embodiment are shown in FIGS. 5A, 5B, 9A and 9B, as described herein. According to yet another embodiment, the system for measuring tether departure angle, α, may further include two step-like brackets configured to secure the respective distal ends of the angled support brackets to the opposed ends of the bridge plate. Particular embodiments of step-like brackets 318 are illustrated in FIGS. 5A, 5B and 9B, as described herein. According to still yet another embodiment of a system for measuring tether departure angle, α, the opposed ends of the bridge plate may be mated in tongue and groove with the respective distal ends of the angled support brackets.

According to one embodiment of a system for measuring tether departure angle, α, the triangle may include a side b of the triangle extending from the tether guide departure point to an intersection of the side a at the tether. According to this embodiment, the triangle may further include an angle A measured between the sides b and c. According to this embodiment, the triangle may further include an angle C measured between the sides a and b. According to this embodiment, the triangle may further include the tether departure angle, α, is measured between the side band a horizontal line.

According to one embodiment of a system for measuring tether departure angle, α, the output of the optical measurement device may include a series of returns in polar coordinates. According to this particular system embodiment, each of the returns may then be converted to Cartesian coordinates by the processor. According to this particular system embodiment, the Cartesian formatted returns may then be Cartesian box filtered to fall within predetermined minimum and maximum x and y positions of the tether within a field of view of the optical measurement device by the processor, thus producing box filtered returns. According to this particular system embodiment, each of the box filtered returns may then be morphologically filtered by the processor by combining individual returns into groupings of connected box filtered returns that are adjacent to other box filtered returns, wherein each of the groupings has an associated size, the associated size defined by a number of the individual box filtered returns that comprise the respective grouping. According to this particular system embodiment, a largest of the groupings may be selected by the processor. According to this particular system embodiment, the processor may then calculate a centroid position of the largest grouping along with its associated distance, a. According to a particular embodiment of a system for measuring tether departure angle, α, the departure angle, α, is calculated according to Eq. 6.

An embodiment of a kit for upgrading a winch to optically measure a tether departure angle, the winch including a base frame configured for mounting to a surface vehicle (SV), a passive tether guide mounted to the base frame from which the tether departure angle is measured relative to horizontal, the winch further including a reel supported between two base frame support arms of the base frame, the reel configured to reel and payout an umbilical tether in coordination with the passive tether guide and rotationally driven by a motor, the tether connected at one end to the winch mounted to the SV, the tether passing through the passive tether guide, and the tether connected at an opposite end to an UAV is disclosed. The embodiment of the kit may include a support structure. According to this embodiment of the kit, the support structure may further include two angled support brackets, each angled support bracket having a proximal end and a distal end, each of the proximal ends configured for mounting to a respective one of the two base frame support arms. According to this embodiment of the kit, the support structure may further include a bridge configured to connect between the distal ends of the two angled support brackets. The embodiment of the kit may further include an optical measurement device configured for mounting to the bridge and aimed toward the tether during operation of the winch. According to this embodiment of the kit, the optical measurement device may further be configured to output dynamic distance measurements from the optical measurement device to the tether during operation of the winch, the dynamic distance measurements may be used to calculate the tether departure angle.

According to another embodiment of the kit, the support structure may further include two step-like brackets for securing the two angled support brackets to the bridge. Particular embodiments of step-like brackets are illustrated in FIGS. 5A, 5B and 9B. According to yet another embodiment of the kit, the optical measurement device may be 2D LIDAR. According to a particular embodiment of the kit, the 2D LIDAR may be a Hokuyo® brand LIDAR with model number UTM-30LX-EW.

According to one embodiment, the kit may further include a processor for receiving the output of the optical measurement device, the output comprising a series of returns from within an area slice within a field-of-view (FoV) of the optical measurement device. According to this embodiment, each return may be provided in polar coordinates including a range from the optical measurement device to the tether and an angle relative to an origin angle. According to this embodiment of the kit, the processor may be configured to convert each of the polar coordinate returns into Cartesian coordinate returns. According to this embodiment of the kit, the processor may further be configured to box filter only the Cartesian coordinate returns falling within predetermined minimum and maximum x and y positions of the tether within a field of view of the optical measurement device, thereby producing box filtered returns. According to this embodiment of the kit, the processor may then be configured to morphologically filter each of the box filtered returns by combining individual returns into groupings of connected box filtered returns that are adjacent to other box filtered returns, each of the groupings further having an associated size, the associated size defined by a number of the individual box filtered returns that comprise the respective grouping. According to this embodiment of the kit, the processor may further be configured to select a largest of the groupings and then calculates a centroid position of the largest grouping and its associated distance, a.

According to still yet another embodiment of the kit, the departure angle, α, may be calculated according to Eq. 6, wherein distance, a, forms side a of a triangle, side c of the triangle is a distance from the optical measurement device to a tether departure point on the passive tether guide, side b of the triangle is the distance from the tether departure point to an intersection with side a and the tether, angle B is measured between the sides a and c, angle θ is measured between a vertical line and side c.

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Finally, terms of degree such as “substantially”, “about” and “approximately” as used herein mean a reasonable amount of deviation of the modified term such that the end result is not significantly changed. In understanding the scope of the present invention, the term “measured” as used herein refers to active measurement which when applied to a distance should be interpreted as “determined by the geometric distance between two points”. Similarly, the term “measured” when applied to an angle should be interpreted a “a geometric angle between two lines”.

From the above description of the embodiments of the system and method for optical tether departure angle measurement from winch, it is manifest that various alternative structures may be used for implementing features of the present invention without departing from the scope of the claims. The described embodiments are to be considered in all respects as illustrative and not restrictive. It will further be understood that the present invention may suitably comprise, consist of, or consist essentially of the component parts, method steps and limitations disclosed herein. The method and/or apparatus disclosed herein may be practiced in the absence of any element that is not specifically claimed and/or disclosed herein.

While the foregoing advantages of the present invention are manifested in the detailed description and illustrated embodiments of the invention, a variety of changes can be made to the configuration, design and construction of the invention to achieve those advantages. Hence, reference herein to specific details of the structure and function of the present invention is by way of example only and not by way of limitation.

What is claimed is:

1. A system for measuring tether departure angle, α, from a winch mounted to a surface vehicle (SV) used to reel and payout an umbilical tether attached to an uncrewed aerial vehicle (UAV), the system comprising:
an support structure connected to the winch;
an optical measurement device attached to the support structure and configured for optically measuring a dynamic distance, a, along an optical path from the optical measurement device to the tether extending from a tether guide departure point on the winch during operation of the tethered UAV; and
a processor in communication with the optical measurement device for calculating the tether departure angle, α, using: (1) the dynamic distance, a, output from the optical measurement device and forming side a of a triangle, (2) a predetermined distance, c, measured from the optical measurement device to a tether guide departure point on the winch forming side c of the triangle, (3) a predetermined angle, B, measured between the sides a and c of the triangle and (4) a predetermined angle, θ, measured between a vertical line and the side c of the triangle.

2. The system of claim 1, wherein the support structure further comprises:
two angled support brackets, each of the angled support brackets configured with a proximal end for mounting to respective base frame support arms; and
a bridge plate having opposed ends configured for attachment to respective distal end of the two angled support brackets.

3. The system of claim 2, further comprising two step-like brackets configured to secure the respective distal ends of the angled support brackets to the opposed ends of the bridge plate.

4. The system of claim 2, wherein the opposed ends of the bridge plate are mated in tongue and groove with the respective distal ends of the angled support brackets.

5. The system of claim 2, wherein the optical measurement device comprises 2-dimensional (2D) light detection and ranging (LIDAR).

6. The system of claim 1, wherein the triangle further comprises a side b of the triangle extending from the tether guide departure point to an intersection of the side a at the tether, an angle A measured between the sides band c, an angle C measured between the sides a and b, and the tether departure angle, α, is measured between the side b and a horizontal line.

7. The system of claim 1, wherein output of the optical measurement device comprises a series of returns in polar coordinates, the processor further configured for:
converting each of the polar coordinate returns into Cartesian coordinate returns;
Cartesian box filtering each of the Cartesian coordinate returns to predetermined minimum and maximum x and y positions of the tether within a field of view of the optical measurement device to produce box filtered returns;
morphologically filtering each of the box filtered returns by combining individual box filtered returns into groupings of connected box filtered returns that are adjacent to other box filtered returns, each of the groupings further having an associated size, the associated size defined by a number of the individual box filtered returns that comprise the respective grouping;
selecting a largest of the groupings as representing the tether; and
calculating a centroid position of the largest of the groupings and its associated distance, a.

8. The system of claim 1, wherein the departure angle, α, is calculated according to equation,
$$α = 90 ° - arcsin ( \frac{a sin ( B )}{\sqrt{{a}^{2} + {c}^{2} - 2 a c cos ( B )}} ) - θ .$$

9. A method for measuring tether departure angle, α, from a winch mounted to a surface vehicle (SV) used to reel and payout an umbilical tether attached to an unmanned aerial vehicle (UAV) under slack tether control, the method comprising:
providing a support structure connected to the winch;
providing an optical measurement device attached to the support structure and configured for generating a series of returns from within an area slice within a field-of-view (FoV) including the tether, each return provided in polar coordinates including a range from the optical measurement device to the tether and an angle relative to an origin angle;
converting each return to Cartesian coordinates;
box filtering each of the Cartesian returns to eliminate Cartesian returns outside of minimum and maximum x and y positions of the tether within the FoV to obtain box filtered returns;
morphologically filtering each of the box filtered returns by grouping adjacent box filtered returns into groupings, each grouping having a size based on total number of adjacent returns to obtain sized groupings;
selecting a largest of the sized groupings as most likely to represent the tether;
determining a centroid position within the largest grouping and a distance, a, from the optical measurement device to the centroid position; and
determining the tether departure angle, α, using:
the distance, a, representing side a of a triangle;
a predetermined distance, c, measured from the optical measurement device to a tether guide departure point on the winch, the distance, c, representing side c of the triangle;
a predetermined angle, B, measured between the sides a and c of the triangle; and
a predetermined angle, θ, measured between a vertical line and the side c of the triangle.

10. The method of claim 9, wherein the triangle further comprises a side b of the triangle extending from the tether guide departure point to an intersection of the side a at the tether, an angle A measured between the sides band c, an angle C measured between the sides a and b, and the tether departure angle, α, is measured between the side b and a horizontal line.

11. The method of claim 10, wherein the departure angle, α, is calculated according to equation,
$$α = 90 ° - arcsin ( \frac{a sin ( B )}{\sqrt{{a}^{2} + {c}^{2} - 2 ac cos ( B )}} ) - θ .$$

12. The method of claim 9, wherein the optical measurement device comprises 2-dimensional (2D) light detection and ranging (LIDAR).

13. A kit for upgrading a winch to optically measure a tether departure angle, the winch including a base frame configured for mounting to a surface vehicle (SV), a passive tether guide mounted to the base frame from which the tether departure angle is measured relative to horizontal, the winch further including a reel supported between two base frame support arms of the base frame, the reel configured to reel and payout an umbilical tether in coordination with the passive tether guide and rotationally driven by a motor, the tether connected at one end to the winch mounted to the SV, the tether passing through the passive tether guide, and the tether connected at an opposite end to an uncrewed aerial vehicle (UAV), the kit comprising:
a support structure including:
two angled support brackets, each angled support bracket having a proximal end and a distal end, each of the proximal ends configured for mounting to a respective one of the two base frame support arms; and
a bridge configured to connect between the distal ends of the two angled support brackets; and
an optical measurement device configured for mounting to the bridge and aimed toward the tether during operation of the winch and configured to output dynamic distance measurements from the optical measurement device to the tether during operation of the winch, the dynamic distance measurements used to calculate the tether departure angle.

14. The kit of claim 13, wherein the support structure further includes two step-like brackets for securing the two angled support brackets to the bridge.

15. The kit of claim 13, wherein the optical measurement device comprises 2-dimensional (2D) light detection and ranging (LIDAR).

16. The kit of claim 13, further comprising a processor for receiving the output of the optical measurement device, the output comprising a series of returns from within an area slice within a field-of-view (FoV), each return provided in polar coordinates including a range from the optical measurement device to the tether and an angle relative to an origin angle.

17. The kit of claim 16, wherein the processor converts each of the polar coordinate returns into Cartesian coordinate returns, box filters the Cartesian coordinate returns to predetermined minimum and maximum x and y positions of the tether within a field of view of the optical measurement device producing box filtered returns, each of the box filtered returns morphologically filtered by combining individual returns into groupings of connected returns that are adjacent to other returns, each of the groupings further having an associated size, the associated size defined by a number of the individual returns that comprise the respective grouping, selecting a largest of the groupings, calculating a centroid position of the largest grouping and its associated distance, a.

18. The kit of claim 17, wherein the departure angle, α, is calculated according to equation,
$$α = 90 ° - arcsin ( \frac{a sin ( B )}{\sqrt{{a}^{2} + {c}^{2} - 2 ac cos ( B )}} ) - θ .$$
wherein distance, a, forms side a of a triangle, side c of the triangle is a distance from the optical measurement device to a tether departure point on the passive tether guide, side b of the triangle is the distance from the tether departure point to an intersection with side a and the tether, angle B is measured between the sides a and c, angle θ is measured between a vertical line and side c.
